(19) United States
(12) Patent Application Publication
(10) Pub. No.: US 2013/0085066 A1
(43) Pub. Date: Apr. 4, 2013

(54) Method for Increasing the Health of a Plant

(71) Applicants: Marco-Antonio Tavares-Rodrigues, Sao Paulo (BR); Ademar De Geroni Junior, Speyer (DE); Marcelo Batistela, Londrina (BR); Eduardo de Lima Leduc, Sao Paulo (BR)

(72) Inventors: Marco-Antonio Tavares-Rodrigues, Sao Paulo (BR); Ademar De Geroni Junior, Speyer (DE); Marcelo Batistela, Londrina (BR); Eduardo de Lima Leduc, Sao Paulo (BR)

(73) Assignee: BASF SE, Ludwigshafen (DE)

(21) Appl. No.: 13/700,505

(22) PCT Filed: May 27, 2011
(86) PCT No.: PCT/EP11/58734

§ 371 Date: Nov. 28, 2012

(30) Foreign Application Priority Data
May 31, 2010 (EP) 10164482.1

(51) Int. Cl. A01N 47/34; A01N 57/20

(52) U.S. Cl. CPC A01N 47/34; A01N 57/20
USPC 504/206; 514/383

(57) ABSTRACT

The present invention relates to a method for increasing the health of a plant comprising the steps:
1) applying to plant propagation material a mixture comprising pyraclostrobin, fipronil and thiophanate-methyl; and
2) applying to the resulting plant, part of the plant and/or locus where the plant is growing, at any time during the reproductive growth stage, at least once pyraclostrobin or a mixture comprising pyraclostrobin and at least one insecticide or fungicide.

In addition, the invention relates to a method, wherein the plant propagation material in step 1) and the resulting plant in step 2) are resistant to glyphosate.

Furthermore, the invention relates to the use of a mixture comprising pyraclostrobin, fipronil and thiophanate-methyl as seed treatment in combination with pyraclostrobin as foliar treatment for increasing the health of a plant.

The present invention relates to a method for increasing the health of a plant comprising the steps:
1) applying to plant propagation material a mixture comprising pyraclostrobin, fipronil and thiophanate-methyl; and
2) applying to the resulting plant, part of the plant and/or locus where the plant is growing, at any time during the reproductive growth stage, at least once pyraclostrobin or a mixture comprising pyraclostrobin and at least one insecticide or fungicide.

In an especially preferred embodiment, the present invention relates to a method, wherein the plant propagation material in step 1) and the resulting plant in step 2) are resistant to glyphosate.

In addition, the invention relates to the use of a mixture comprising pyraclostrobin, fipronil and thiophanate-methyl as seed treatment in combination with foliar application of pyraclostrobin for increasing the health of a plant.

According to the FAO (2004), population will continue to grow from currently 6.07 billion to 8.9 billion in 2050. Highest growth rates are expected in the developing countries. Obviously, the more people there are on Earth, the more resources are needed to meet their basic needs such as food and water. The United Nations Organization has pointed out that the food production has to nearly double to feed the expected global population. Even though there has been an impressive growth in food production during the last decades, which can mainly be attributed to the development of improved, disease-resistant varieties of staple crops and the increased use of chemical fertilizers and pesticides, the food production does not keep up with the rapid population growth. One of the most severe consequences is the expansion of arable land by cutting down forests or by irrigating cropland with salty water leading to salinization of the soils and widespread land degradation. Such inappropriate farming practices may impoverish and erode the soil; reduce vegetation and result in over-use and improperly use of agrochemicals. As a result, less arable and productive land is available. Taking climatic changes into account, it must additionally be expected that the yield will decline in many areas of the world due to adverse weather conditions. With respect to the growing world population, the increase of crop yield must be regarded as a global challenge.

Besides the growing world population which directly leads to an increased food and energy requirement, the growing wealth results in an increased meat consumption and consequently to an increase in feed demand. In addition, quality issues become more and more important. It is known that the food quality is regarded by many consumers as the most important parameter. Various parameters determine the food quality. Besides genetic aspects, the cropping system including the optimal nutrition as well as the protection against abiotic and biotic stress factors can alter the overall quality of plants and their products as an indicator of plant health to a substantial extent. Complying with the quality standards and at the same time to remain competitive at the market, ecologically sound and economically viable production methods are essential to the farmer.

Fipronil is a broad spectrum insecticide which belongs to the group of GABA antagonists. GABA antagonists and methods for producing them are generally known. Fipronil can be used to control insects when applied as a soil or seed treatment. WO 09/024,546 discloses that GABA antagonists such as fipronil are capable of increasing the yield of a plant even under low N content.

Thiophanate-methyl is a systemic fungicide with protective and curative action. It is being absorbed by the leaves and roots. The analogous diethyl ester has the ISO common name thiophanate.

Pyraclostrobin is a fungicide which belongs to the class of strobilurins. It is known from the literature that pyraclostrobin is capable of bringing about increased yields in crop plants in addition to its fungicidal action. In addition, WO 01/82701 discloses the use of pyraclostrobin for inducing viral resistance in plants; WO 03/075663 discloses the use of pyraclostrobin for immunizing plants against bacterioses; WO 07/104,660 discloses the use of pyraclostrobin for improving the tolerance of plants to chilling temperatures and/or frost while WO 08/059,053 discloses the use of pyraclostrobin for increasing the dry biomass and CO₂ sequestration of plants.

US 2006/111239 discloses mixtures of pyraclostrobin and glyphosate in modified leguminoses.

Glyphosate (N-(phosphonomethyl)glycine) is a well known broad-spectrum systemic herbicide which is used to kill weeds. Certain crops have been genetically engineered to be resistant to glyphosate. Methods far generating plants which are resistant to the effect of glyphosate are described in the literature (EP-A 218 571, EP-A 293 358, WO-A 92/00377 and WO-A 92/04449). Chemical Abstracts, 123, No. 21 (1995) A.N. 281158c describes the generation of glyphosate-resistant soybean plants. Other glyphosate-resistant plants can be generated in a similar manner. Currently, genetically engineered glyphosate resistant crops include soy, maize (corn), sorghum, canola, alfalfa, and cotton. It is very likely that many other crops such as wheat will be made glyphosate resistant in the close future.

Soybeans that were made tolerant to glyphosate were introduced to U.S. farmers in 1996. Today glyphosate-tolerant soybeans constitute over 90% of all soybeans planted in the United States and represent by far the biggest proportion among the genetically engineered crops. The ability to apply glyphosate to glyphosate resistant crops has provided a high level of convenience to farmers by reducing time and costs when compared to techniques applied before.

It is known from WO 97/36488 that the application of glyphosate derivatives in glyphosate tolerant plants selected from the group consisting of sugar beet, fodder beet, maize, oilseed rape and cotton may bring about increased yields. Furthermore, it is known from U.S. Pat. No. 3,988,142 that the sublethal application of glyphosate in plants such as sugar cane increases starch and sugar production and thus the overall yield of the plant.

WO 09/098,218 relates to a method for improving the plant health of at least one plant variety, which method comprises treating the plant and/or the locus where the plant is growing or is intended to grow with a mixture comprising an amide and a further fungicide or an insecticide or a herbicide wherein the herbicide is selected from the group consisting of glyphosate, glyphosinate and sulfonisate.

WO 2004/1043150 relates to a method for increasing the yield in glyphosate-resistant legumes, which comprises treating the plants or the seed with a mixture comprising a strobilurine compound and a glyphosate derivate in synergistically active amounts.

WO 2005/058040 discloses the mixture of pyraclostrobin, fipronil and thiophanate-methyl and a method for controling phytopathogenic fungi and harmful insects. However, there is no hint towards the use of the mixture within a method according to the invention for increasing the health of a plant.

WO 2008/049 describes a method for controlling asian soybean rust comprising a) applying a pesticidal composition (A) comprising one or more compounds selected from flutriafol, triticonazole, tebuconazole, ipconazole, epoxyconazole, orysastrobin, prothioconazole, fluoxastrobin, azoxystrobin, furametpyr and cyproconazole to a glyphosate tolerant soybean plant propagation material, and b) applying a pesticidal composition (B) comprising glyphosate to the resulting soybean plant.

WO 2010/015578 discloses a method for controlling the plant pathogenic fungus Rhizoctonia solani in legumes comprising treating the seeds with a mixture comprising thiophanate-methyl and pyraclostrobin.

All compounds listed in the present application as well as their pesticidal action and methods for producing them are generally known. For instance, the commercially available compounds may be found in The Pesticide Manual, 14th Edition, British Crop Protection Council (2006) among other publications.

None of these references, however, disclose the method as defined at the outset and its positive effects on the health of a plant such as the strong increase of yield.

In crop protection, there is a continuous need for methods that improve the health of plants. Healthier plants are desirable since they result among others in better yields and/or a better quality of the crop plants. Healthier plants also better resist to biotic and/or abiotic stress. A high resistance against biotic stresses in turn allows the person skilled in the art to reduce the quantity of pesticides applied and consequently to slow down the development of resistances against the respective pesticides.

To be able to safeguard and increase the yield and quality of crops under constant or even declining arable land as described above, new approaches such as innovative cropping systems resulting in healthy plants need to be applied. It was therefore an object of the present invention to provide a method which solves the problems outlined above, and which should, in particular, improve the health of a plant, in particular the yield of plants.

We have found that this object is achieved by the method defined at the outset which provides enhanced plant health effects such as a strong yield increase compared to the plant health effects that are possible by applying comparable crop protection compounds within cropping systems known to the farmer at the present time.

Glyphosate is frequently used as salt, their use being a preferred embodiment of the present invention. Suitable salts of glyphosate include those salts of glyphosate, where the counterion is an agriculturally acceptable cation. Suitable examples of such salts are glyphosate-ammonium, glyphosate-diammonium, glyphoste-dimethylammonium, glyphosate-isopropylammonium, glyphosate-potassium, glyphosate-sodium, glyphosate-trimesium as well as the ethanolamine and diethanolamine salts.

In one embodiment, the method according to the invention for increasing the health of a plant comprises the steps:
1) applying to plant propagation material a mixture comprising pyraclostrobin, fipronil and thiophanate-methyl; and
2) applying to the resulting plant, part of the plant and/or locus where the plant is growing, at any time during the reproductive growth stage at least once pyraclostrobin or a mixture comprising pyraclostrobin and at least one insecticide or fungicide.

In an especially preferred embodiment of the method according to the invention, the mixture applied in step 1), comprising pyraclostrobin, fipronil and thiophanate-methyl, is applied to glyphosate-resistant plant propagation material.

In one embodiment, the method according to the invention is used for increasing the health of a glyphosate-resistant plant comprising the steps:
1) applying to glyphosate-resistant plant propagation material a mixture comprising pyraclostrobin, fipronil and thiophanate-methyl; and
2) applying to the resulting glyphosate-resistant plant, part of the plant and/or locus where the plant is growing, at any time during the reproductive growth stage at least once pyraclostrobin or a mixture comprising pyraclostrobin and at least one insecticide or fungicide.

In another embodiment of the invention, the method for increasing the health of a plant comprises the steps:
1) applying to plant propagation material a mixture comprising pyraclostrobin, fipronil and thiophanate-methyl; and
2) applying to the resulting plant, part of the plant and/or locus where the plant is growing, at any time during the reproductive growth stage at least once pyraclostrobin or a mixture comprising pyraclostrobin and at least one insecticide or fungicide; wherein the insecticide in step 2) is selected from the following groups:
(I-1) organo(thio)phosphate compounds selected from acephate, chlorfenvinphos, chlorpyrifos, chlorpyrifos-methyl, pyraclofos, quinalphos and quinalphos-methyl;
(I-2) carbamate compounds selected from aldicarb, methomyl, pirimicarb, thiodicarb and triazamate;
(I-3) pyrethroid compounds selected from bifenthrin, bioethanomethrin, beta-cyfluthrin, biopermethrin, lambda-cyhalothrin, gamma-cyhalothrin, cypermethrin, alpha-cypermethrin, beta-cypermethrin, theta-cypermethrin, zeta-cypermethrin, deltamethrin, esfenvalerate, etofenprox, fenvalerate, flufenprox, halfenprox, permethrin, protrifenbute, silafluofen, sulfoxime and thiofluoximate;
(I-4) juvenile hormone mimics selected from hydroprene, kinoprene, methoprene, fenoxycarb, pyriproxyfen, dayoutong, epofenonane and triprene;
(I-5) nicotinic receptor agonists/antagonists compounds selected from acetamiprid, bensultap, cartap, clothianidin, dinotefuran, imidacloprid, imidaclothiz, thiamethoxam, nitenpyram, paichongding, nithiazine, spinosad (allosteric agonist), spinetoram (allosteric agonist), thiacloprid, thiocyclam, thiosultap, tazimcarb and polythialan;
(I-6) GABA gated chloride channel antagonist compounds selected from acetoprole, ethiprole, fipronil, pyrafluprole, pyriprole and vaniliprole;
(I-7) METI I compounds selected from pyrimidifen, pyridaben, tebufenpyrad, tolfenpyrad and flufenerim;
(I-8) hydramethylnon;
(I-9) chlorfenapyr;
(I-10) diafenthiuron;
(I-11) moulting disruptors selected from cyromazine, furan tebufenozide, methoxyfenozide and tebufenozide;
(I-12) moulting hormones selected from α-ecdysone and ecdysterone;
(I-13) sodium channel blocker compounds: indoxacarb, metaflumizone;
(I-14) flonicamid;
(I-15) urea insecticides selected from flucofuron and sulcofuron;
(I-16) chitin synthesis inhibitors selected from buprofezin, bistrifluoron, chlorbenzuron, chlorfluazuron, diflubenzuron, dichlorbenzuron, flucycloxuron, flufenoxuron, hexaflumuron, lufenuron, novaluron, noviflumuron, penfluoron, teflubenzuron and triflumuron;
(I-17) lipid biosynthesis inhibitors selected from spiromesifen and spirotetramat;
(I-18) flubendiamide;
(I-19) anthranilamide compounds selected from chloranthraniliprole and cyantraniliprole;
(I-20) various compounds selected from copper naphthenate, nifluridide, plifenate, azadirachtin, sulfluramid, diofenolan, dicyclanil, metoxadiazone, dimetilan, isoprothiolane, malonoben, pyridalyl, sulfoxaflor and triarathene;
(I-21) chloride channel activators selected from abamectin and doramectin; and
(I-22) octapaminergic agonists selected from amitraz and chlordimeform.

In a preferred embodiment of the invention, the insecticide selected from the above listed groups (I-1) to (I-22) is applied in step 2) to a glyphosate-resistant plant.

In a preferred embodiment of the invention, the method for increasing the health of a plant comprises the steps:
1) applying to plant propagation material a mixture comprising pyraclostrobin, fipronil and thiophanate-methyl; and
2) applying to the resulting plant, part of the plant and/or locus where the plant is growing, at any time during the reproductive growth stage at least once pyraclostrobin or a mixture comprising pyraclostrobin and at least one insecticide or fungicide; wherein the insecticide in step 2) is selected from the following groups:
(I-1) organo(thio)phosphate compounds selected from chlorpyrifos, chlorpyrifos-methyl and pyraclofos;
(I-2) carbamate compounds selected from aldicarb, methomyl, thiodicarb and triazamate;
(I-3) pyrethroid compounds selected from bifenthrin, bioethanomethrin, beta-cyfluthrin, biopermethrin, lambda-cyhalothrin, gamma-cyhalothrin, cypermethrin, alpha-cypermethrin, beta-cypermethrin, zeta-cypermethrin, deltamethrin, esfenvalerate, fenvalerate, sulfoxime and thiofluoximate;
(I-4) juvenile hormone mimics selected from fenoxycarb and pyriproxyfen;
(I-5) nicotinic receptor agonists/antagonists compounds selected from acetamiprid, clothianidin, dinotefuran, imidacloprid, imidaclothiz, thiamethoxam, nitenpyram, paichongding, thiacloprid and tazimcarb;
(I-6) GABA gated chloride channel antagonist compounds selected from acetoprole, ethiprole, fipronil, pyrafluprole, pyriprole and vaniliprole;
(I-7) METI I compounds selected from pyridaben, tebufenpyrad and tolfenpyrad;
(I-8) hydramethylnon;
(I-9) chlorfenapyr;
(I-10) diafenthiuron;
(I-11) moulting disruptors selected from cyromazine, furan tebufenozide, methoxyfenozide and tebufenozide;
(I-12) moulting hormones selected from α-ecdysone and ecdysterone;
(I-13) sodium channel blocker compounds selected from indoxacarb and metaflumizone;
(I-14) flonicamid;
(I-15) flucofuron;
(I-16) chitin synthesis inhibitors selected from buprofezin, bistrifluoron, chlorbenzuron, chlorfluazuron, diflubenzuron, dichlorbenzuron, flucycloxuron, flufenoxuron, hexaflumuron, lufenuron, novaluron, noviflumuron, penfluoron, teflubenzuron and triflumuron;
(I-17) lipid biosynthesis inhibitors selected from spiromesifen and spirotetramat;
(I-18) flubendiamide;
(I-19) anthranilamide compounds selected from chloranthraniliprole and cyantraniliprole; and
(I-20) various compounds selected from dicyclanil, metoxadiazone, dimetilan, isoprothiolane, malonoben, sulfoxaflor and triarathene.

In a preferred embodiment of the invention, the insecticide selected from the above listed groups (I-1) to (I-20) is applied in step 2) to a glyphosate-resistant plant.

In a further preferred embodiment of the invention, the method for increasing the health of a plant comprises the steps:
1) applying to plant propagation material a mixture comprising pyraclostrobin, fipronil and thiophanate-methyl; and
2) applying to the resulting plant, part of the plant and/or locus where the plant is growing, at any time during the reproductive growth stage at least once pyraclostrobin or a mixture comprising pyraclostrobin and at least one insecticide or fungicide; wherein the further fungicide in step b) is selected from the following groups:
(F-1) amine derivatives selected from fenpropimorph and fenpropidin;
(F-2) azole compounds selected from bitertanol, bromoconazole, cyproconazole, difenoconazole, diniconazole, enilconazole, epoxiconazole, fenbuconazole, fluquiconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizol and triticonazole;
(F-3) carboxamide compounds selected from the group consisting of bixafen, boscalid, carboxin, fluxapyroxad, isopyrazam, oxycarboxin, sedaxane and fluopyram; and
(F-4) heterocyclic compounds selected from benomyl, carbendazim, thiabendazole and thiophanate-methyl.

In an especially preferred embodiment of the method, the further fungicide in step 2) is selected from the following groups:
(F-1) amine derivatives selected from fenpropimorph and fenpropidin;
(F-2) azole compounds selected from cyproconazole, difenoconazole, epoxiconazole, flutriafol, metconazole, propiconazole, prothioconazole, tebuconazole, tetraconazole and triticonazole;
(F-3) carboxamide compounds selected from the group consisting of bixafen, boscalid, fluxapyroxad, isopyrazam, sedaxane and fluopyram; and
(F-4) heterocyclic compounds selected from carbendazim and thiophanate-methyl.

In a preferred embodiment of the invention, the fungicide selected from the above listed groups (F-1) to (F-4) is applied in step 2) to a glyphosate-resistant plant.

In an especially preferred embodiment of the method, the further fungicide in step 2) is fenpropimorph.

In an especially preferred embodiment of the method, the further fungicide in step 2) is epoxiconazole, metconazole or prothioconazole.

In an especially preferred embodiment of the method, the further fungicide in step 2) is boscalid or fluxapyroxad. Fluxapyroxad being even more preferred.

In an especially preferred embodiment of the method, the further fungicide in step 2) is thiophanate-methyl.

In an especially preferred embodiment of the method, the further fungicide in step 2) is epoxiconazole.

In an especially preferred embodiment of the invention, the method for increasing the health of a plant comprises the steps:
1) applying to plant propagation material a mixture comprising pyraclostrobin, fipronil and thiophanate-methyl; and
2) applying to the resulting plant, part of the plant and/or locus where the plant is growing, at any time during the reproductive growth stage at least once pyraclostrobin.

In another especially preferred embodiment of the invention, the method is used for increasing the health of a glyphosate-resistant plant comprising the steps:
1) applying to glyphosate-resistant plant propagation material a mixture comprising pyraclostrobin, fipronil and thiophanate-methyl; and
2) applying to the resulting glyphosate-resistant plant, part of the plant and/or locus where the plant is growing, at any time during the reproductive growth stage at least once pyraclostrobin.

In another especially preferred embodiment of the invention, the method for increasing the health of a plant comprises the steps:
1) applying to plant propagation material a mixture comprising pyraclostrobin, fipronil and thiophanate-methyl; and
2) applying to the resulting plant, part of the plant and/or locus where the plant is growing, at any time during the reproductive growth stage at least once a mixture comprising pyraclostrobin and epoxiconazole.

In another especially preferred embodiment of the invention, the method is used for increasing the health of a glyphosate-resistant plant comprising the steps:
1) applying to glyphosate-resistant plant propagation material a mixture comprising pyraclostrobin, fipronil and thiophanate-methyl; and
2) applying to the resulting glyphosate-resistant plant, part of the plant and/or locus where the plant is growing, at any time during the reproductive growth stage at least once a mixture comprising pyraclostrobin and epoxiconazole.

In one embodiment, the method according to the invention comprises an additional step called 1b) which comprises the application of a strobilurin fungicide or glyphosate or a mixture comprising glyphosate and at least one strobilurin at any time during the vegetative growth stage.

In one embodiment, a strobilurin fungicide selected from the group consisting of azoxystrobin, dimoxystrobin, enestroburin, fluoxastrobin, kresoxim-methyl, metominostrobin, picoxystrobin, pyraclostrobin, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5[1-(3-methylbenzyloxyimino)ethyl]benzyl)carbamate and 2 (2-(3-(2,6-dhchlorophenyl)-1-methyl-allylideneaminooxymethyl)-phenyl)-2-methoxyimino-N methyl-acetamide is applied in step 1b). In a preferred embodiment, the strobilurin fungicide is selected from the group consisting of azoxystrobin, picoxystrobin, pyraclostrobin and trifloxystrobin. In more preferred embodiment, pyraclostrobin is applied in step 1b).

The plants to be treated in step 1b) may or may not be glyphosate resistant.

Provided that the plant propagation material and consequently, the resulting plant is glyphosate resistant, the method according to the invention may comprise as a third step the application of glyphsosate as step 1b).

In a preferred embodiment the method according to the invention additionally comprises a third step 1b), wherein glyphosate or a mixture comprising glyphosate and a strobilurin fungicide is applied at least once to the glyphosate-resistant plant, part of the plant and/or locus where the plant is growing, at any time during the vegetative growth stage.

In another preferred embodiment of the method according to the invention, glyphosate or a mixture comprising glyphosate and a strobilurin fungicide is applied at step 1b) during the BBCH (Biologische Bundesanstalt, Bundessortenamt and CHemische Industrie) growth stages 11 through 19.

In a preferred embodiment, the mixture applied in step 1b) comprises glyphosate and a strobilurin fungicide selected from the group consisting of azoxystrobin, dimoxystrobin, enestroburin, fluoxastrobin, kresoxim-methyl, metominostrobin, picoxystrobin, pyraclostrobin, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5 [1-(3-methylbenzyloxyimino)ethyl]benzyl)carbamate and 2 (2-(3-(2,6-di [symbol] chlorophenyl)-1-methyl-allylideneaminooxymethyl)-phenyl)-2-methoxyimino-N methyl-acetamide.

In an especially preferred embodiment, the mixture applied in step 1b) comprises glyphosate and a strobilurin fungicide selected from the group consisting of azoxystrobin, picoxystrobin, pyraclostrobin and trifloxystrobin.

In even more preferred embodiment, the mixture applied in step 1b) comprises glyphosate and pyraclostrobin.

Accordingly, in another especially preferred embodiment of the invention, the method for increasing the health of a glyphosate-resistant plant comprises the steps:
1) applying to glyphosate-resistant plant propagation material a mixture comprising pyraclostrobin, fipronil and thiophanate-methyl;
1b) applying to the resulting glyphosate-resistant plant, part of the plant and/or locus where the plant is growing at any time during the vegetative growth stage at least once glyphosate or a mixture comprising glyphosate and pyraclostrobin; and
2) applying to the glyphosate-resistant plant, part of the plant and/or locus where the plant is growing, at any time during the reproductive growth stage at least once pyraclostrobin.

All mixtures set forth above are also an embodiment of the present invention.

The remarks as to preferred mixtures, to their preferred use and methods of using them are to be understood either each on their own or preferably in combination with each other.

In the terms of the present invention “mixture” is not restricted to a physical mixture but refers to any preparation form, the use of which is time- and locus-related.

In one embodiment of the invention “mixture” refers to a binary mixture. In yet another embodiment, “mixture” refers to a ternary or quaternary mixture.

In another embodiment of the invention, a “mixture” comprises at least two compounds which are formulated separately but applied to the same plant, plant propagule or locus in a temporal relationship, i.e. simultaneously or subsequently, the subsequent application having a time interval which allows a combined action of the compounds.

One embodiment of the invention is directed to the use of a mixture comprising pyraclostrobin, fipronil and thiophanate-methyl as seed treatment in combination with pyraclostrobin as foliar treatment for increasing the health of a plant.

A further embodiment of the invention is directed to the use of a mixture comprising pyraclostrobin, fipronil and thiophanate-methyl as seed treatment in combination with pyraclostrobin and at least one insecticide or at least one further fungicide as defined above as foliar treatment for increasing the health of a plant.

In one embodiment of the invention, a mixture comprising pyraclostrobin, fipronil and thiophanate-methyl as seed treatment in combination with pyraclostrobin as foliar treatment is used for increasing the yield of a plant.

In one embodiment of the invention, a mixture comprising pyraclostrobin, fipronil and thiophanate-methyl as seed treatment in combination with pyraclostrobin as foliar treatment is used for increasing the vigor of a plant.

In one embodiment of the invention, a mixture comprising pyraclostrobin, fipronil and thiophanate-methyl as seed treatment in combination with pyraclostrobin as foliar treatment is used for increasing the quality of a plant.

In one embodiment of the invention, a mixture comprising pyraclostrobin, fipronil and thiophanate-methyl as seed treatment in combination with pyraclostrobin as foliar treatment is used for increasing the tolerance of a plant against abiotic and/or biotic stress.

In another embodiment of the invention, the active ingredients are used for increasing the health of a plant which is resistant to glyphosate. In this case, glyphosate or a mixture comprising glyphosate and a strobilurin fungicide as defined above may additionally be used as foliar treatment.

Another embodiment is directed to the use of glyphosate or a mixture comprising glyphosate and a strobilurin fungicide selected from the group consisting of azoxystrobin, dimoxystrobin, enestroburin, fluoxastrobin, kresoxim-methyl, metominostrobin, picoxystrobin, pyraclostrobin, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5[1-(3-methylbenzyloxyimino)-ethyl]benzyl)carbamate and 2 (2-(3-(2,6-dhchlorophenyl)-1-methyl-allylideneaminooxymethyl)-phenyl)-2-methoxyimino-N methyl-acetamide as foliar treatment for increasing the health of a plant. Preferably, the yield of a plant is increased.

In one embodiment, pyraclostrobin, fipronil and thiophanate-methyl are applied simultaneously, either separately, or subsequently to plant propagation material in step 1) of the method according to the invention.

In another embodiment, pyraclostrobin, fipronil and thiophanate-methyl are applied simultaneously, either separately, or subsequently to glyphosate-resistant plant propagation material in step 1) of the method according to the invention.

In a preferred embodiment, the plant propagation material in step 1) is seed.

In another preferred embodiment, the plant propagation material in step 1) is glyphosate-resistant seed.

In one embodiment, pyraclostrobin or a mixture comprising pyraclostrobin and at least one insecticide or fungicide, are applied simultaneously, either as a mixture or separately in step 2) of the method according to the invention, as foliar spray treatment (foliar application) to the plant, part of the plant and/or locus where the plant is growing, at any time during the reproductive growth stage. In a preferred embodiment, the plant propagation material and/or the plant is glyphosate resistant.

Furthermore, the individual compounds of the mixtures according to the invention such as parts of a kit or parts of the binary mixture may be mixed by the user himself in a spray tank and further auxiliaries may be added if appropriate (tank mix).

The plants to be treated according to the invention are plants selected from the group consisting of agricultural, silvicultural, ornamental and horticultural plants, each in its natural or genetically modified form. Agricultural plants are especially preferred.

In an especially preferred embodiment, the plants to be treated according to the invention are glyphosate-resistant plants selected from the group consisting of agricultural, silvicultural, ornamental and horticultural plants, each in its natural or genetically modified form. Agricultural plants that are glyphosate-resistant are especially preferred.

It is preferred that the transgenic plant be one having a transgenic event that provides glyphosate resistance. Some examples of such preferred transgenic plants having transgenic events that confer glyphosate resistance are described in U.S. Pat. No. 5,914,451, U.S. Pat. No. 5,866,775, U.S. Pat. No. 5,804,425, U.S. Pat. No. 5,776,760, U.S. Pat. No. 5,633,435, U.S. Pat. No. 5,627,061, U.S. Pat. No. 5,463,175, U.S. Pat. No. 5,312,910, U.S. Pat. No. 5,310,667, U.S. Pat. No. 5,188,642, U.S. Pat. No. 5,145,783, U.S. Pat. No. 4,971,908 and U.S. Pat. No. 4,940,835. More preferably, the transgenic soybean plant has the characteristics of “Roundup-Ready” (RR) transgenic soybeans (available from Monsanto Company, St. Louis, Mo.).

The term “plant” is a synonym of the term “crop plant” which is to be understood as a plant of economic importance and/or a men-grown plant. The term “plant” as used herein includes all parts of a plant such as germinating seeds, emerging seedlings, herbaceous vegetation as well as established woody plants including all belowground portions (such as the roots) and aboveground portions. In a preferred embodiment, the plant is a glyphosate-resistant plant.

In one embodiment, the plant to be treated according to the method of the invention is an agricultural plant. “Agricultural plants” are plants of which a part (e.g. seeds) or all is harvested or cultivated on a commercial scale or which serve as an important source of feed, food, fibres (e.g. cotton, linen), combustibles (e.g. wood, bioethanol, biodiesel, biomass) or other chemical compounds. Preferred agricultural plants are for example cereals, e.g. wheat, rye, barley, triticale, oats, sorghum or rice, beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, oil-seed rape, canola, linseed, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola, sugar cane or oil palm; tobacco; nuts; coffee; tea; bananas; vines (table grapes and grape juice grape vines); hop; turf; natural rubber plants.

In a preferred embodiment of the present invention, agricultural plants are field crops such as potatoes, sugar beets, cereals such as wheat, rye, barley, oats, sorghum, rice, corn, cotton, rape, oilseed rape and canola, legumes such as soybeans, peas and field beans, sunflowers, sugar cane, vegetables such as cucumbers, tomatoes, onions, leeks, lettuce and squashes.

In an especially preferred embodiment of the present invention, the plant to be treated is a plant selected from the group consisting of soybean, sugar cane, sunflower, oilseed rape, rice, corn and cotton. In even more preferred embodiment of the present invention, the plant to be treated is a plant selected from the group consisting of soybean, sugar cane, sunflower, oilseed rape, rice, corn and cotton. In a most preferred embodiment of the present invention, the plant to be treated is a soybean.

In another especially preferred embodiment of the present invention, the plant to be treated is a glyphosate-resistant plant selected from the group consisting of soybean, sugar cane, sunflower, oilseed rape, rice, corn and cotton. In an especially preferred embodiment of the present invention, the plant to be treated is a glyphosate-resistant plant selected from the group consisting of soybean, oilseed rape, corn and cotton. In a most preferred embodiment of the present invention, the plant to be treated is a glyphosate-resistant soybean.

In one embodiment, the plant to be treated according to the method of the invention is a horticultural plant. The term “horticultural plants” are to be understood as plants which are commonly used in horticulture—e.g. the cultivation of ornamentals, vegetables and/or fruits. Examples for ornamentals are turf, geranium, pelargonia, petunia, begonia and fuchsia. Examples for vegetables are potatoes, tomatoes, peppers, cucurbits, cucumbers, melons, watermelons, garlic, onions, carrots, cabbage, beans, peas and lettuce and more preferably from tomatoes, onions, peas and lettuce. Examples for fruits are apples, pears, cherries, strawberry, citrus, peaches, apricots and blueberries.

In one embodiment, the plant to be treated according to the method of the invention is a glyphosate-resistant horticultural plant In one embodiment, the plant to be treated according to the method of the invention is an ornamental plant. “Ornamental plants” are plants which are commonly used in gardening, e.g. in parks, gardens and on balconies. Examples are turf, geranium, pelargonia, petunia, begonia and fuchsia.

In one embodiment, the plant to be treated according to the method of the invention is a glyphosate-resistant ornamental plant

In one embodiment, the plant to be treated according to the method of the invention is a silvicultural plants. The term “silvicultural plant” is to be understood as trees, more specifically trees used in reforestation or industrial plantations. Industrial plantations generally serve for the commercial production of forest products, such as wood, pulp, paper, rubber tree, Christmas trees, or young trees for gardening purposes. Examples for silvicultural plants are conifers, like pines, in particular Pinus spec., fir and spruce, eucalyptus, tropical trees like teak, rubber tree, oil palm, willow (Salix), in particular Salix spec., poplar (cottonwood), in particular Populus spec., beech, in particular Fagus spec., birch, oil palm and oak.

In one embodiment, the plant to be treated according to the method of the invention is a glyphosate-resistant silvicultural plant.

The term “locus” is to be understood as any type of environment, soil, area or material where the plant is growing or is intended to grow as well as the environmental conditions (such as temperature, water availability, radiation) that have an influence on the growth and development of the plant and/or its propagules.

The term “genetically modified plants” is to be understood as plants, which genetic material has been modified by the use of recombinant DNA techniques in a way that under natural circumstances it cannot readily be obtained by cross breeding, mutations or natural recombination.

The term “plant propagation material” is to be understood to denote all the generative parts of the plant such as seeds and vegetative plant material such as cuttings and tubers (e.g. potatoes), which can be used for the multiplication of the plant. This includes seeds, grains, roots, fruits, tubers, bulbs, rhizomes, cuttings, spores, offshoots, shoots, sprouts and other parts of plants, including seedlings and young plants, which are to be transplanted after germination or after emergence from soil, meristem tissues, single and multiple plant cells and any other plant tissue from which a complete plant can be obtained.

The term “propagules” or “plant propagules” is to be understood to denote any structure with the capacity to give rise to a new plant, e.g. a seed, a spore, or a part of the vegetative body capable of independent growth if detached from the parent. In a preferred embodiment, the term “propagules” or “plant propagules” denotes for seed.

The term “BBCH principal growth stage” refers to the extended BBCH-scale which is a system for a uniform coding of phenologically similar growth stages of all mono- and dicotyledonous plant species in which the entire developmental cycle of the plants is subdivided into clearly recognizable and distinguishable longer-lasting developmental phases. The BBCH-scale uses a decimal code system, which is divided into principal and secondary growth stages. The abbreviation BBCH derives from “Biologische Bundesanstalt, Bundessortenamt and CHemische Industrie” (the Federal Biological Research Centre for Agriculture and Forestry (Germany), the Bundessortenamt (Germany) and the chemical industry).

The term “vegetative growth stage” is to be understood to denote the BBCH principal growth stages 1 (leaf development), 2 (formation of side shoots; tillering), 3 (stem elongation or rosette growth, shoot development) and 4 (development of harvestable vegetative plant parts or vegetatively propagated organs).

The term “reproductive growth stage” is to be understood to denote the BBCH principal growth stages 5 (inflorescence emergence; heading), 6 (flowering) and 7 (development of fruit).

The term “synergistically” means that the purely additive (in mathematical terms) plant health-increasing effects of a simultaneous, that is joint or separate application of the compounds according to the invention, or successive application of the compounds according to the invention is surpassed by the application the respective compounds according to the method of the invention.

The term “health of a plant” or “plant health” is defined as a condition of the plant and/or its products. As a result of the improved health, yield, plant vigor, quality and tolerance to abiotic or biotic stress are increased. Noteworthy, the health of a plant when applying the method according to the invention, is increased independently of the pesticidal properties of the active ingredients used because the increase in health is not based upon the reduced pest pressure but instead on complex physiological and metabolic reactions which result for example in an activation of the plant's own natural defense system. As a result, the health of a plant is increased even in the absence of pest pressure.

Accordingly, in an especially preferred embodiment of the method according to the invention, the health of a plant is increased both in the presence and absence of biotic or abiotic stress factors.

The above identified indicators for the health condition of a plant may be interdependent or they may result from each other. An increase in plant vigor may for example result in an increased yield and/or tolerance to abiotic or biotic stress.

One indicator for the condition of the plant is the yield. “Yield” is to be understood as any plant product of economic value that is produced by the plant such as grains, fruits in the proper sense, vegetables, nuts, grains, seeds, wood (e.g. in the case of silviculture plants) or even flowers (e.g. in the case of gardening plants, ornamentals). The plant products may in addition be further utilized and/or processed after harvesting.

In an especially preferred embodiment of the invention, the yield of the treated plant is increased.

In another preferred embodiment of the invention, the yield of the plants treated according to the method of the invention, is increased synergistically.

According to the present invention, “increased yield” of a plant, in particular of an agricultural, silvicultural and/or horticultural plant means that the yield of a product of the respective plant is increased by a measurable amount over the yield of the same product of the plant produced under the same conditions, but without the application of the mixture according to the invention.

Increased yield can be characterized, among others, by the following improved proper-ties of the plant:
increased plant weight
increased plant height
increased biomass such as higher overall fresh weight (FW)
increased number of flowers per plant
higher grain yield
more tillers or side shoots (branches)
larger leaves
increased shoot growth
increased protein content
increased oil content
increased starch content
increased pigment content
increased leaf are index

According to the present invention, the yield is increased by at least 4%, preferable by 5 to 10%, more preferable by 10 to 20%, or even 20 to 30% compared to the untreated control plants or plants treated with pesticides in a way different from the method according to the present invention. In general, the yield increase may even be higher.

A further indicator for the condition of the plant is the plant vigor. The plant vigor becomes manifest in several aspects such as the general visual appearance.

In another especially preferred embodiment of the invention, the plant vigor of the treated plant is increased.

In another preferred embodiment of the invention, the plant vigor of the plants treated according to the method of the invention, is increased synergistically.

Improved plant vigor can be characterized, among others, by the following improved properties of the plant:
improved vitality of the plant
improved plant growth
improved plant development
improved visual appearance
improved plant stand (less plant verse/lodging)
improved emergence
enhanced root growth and/or more developed root system
enhanced nodulation, in particular rhizobial nodulation
bigger leaf blade
bigger size
increased plant weight
increased plant height
increased tiller number
increased number of side shoots
increased number of flowers per plant
increased shoot growth
increased root growth (extensive root system)
increased yield when grown on poor soils or unfavorable climate
enhanced photosynthetic activity (e.g. based on increased stomatal conductance and/or increased CO₂ assimilation rate)
increased stomatal conductance
increased CO₂ assimilation rate
enhanced pigment content (e.g. chlorophyll content)
earlier flowering
earlier fruiting
earlier and improved germination
earlier grain maturity
improved self-defence mechanisms
improved stress tolerance and resistance of the plants against biotic and abiotic stress factors such as fungi, bacteria, viruses, insects, heat stress, cold stress, drought stress, UV stress and/or salt stress
less non-productive tillers
less dead basal leaves
less input needed (such as fertilizers or water)
greener leaves
complete maturation under shortened vegetation periods
less fertilizers needed
less seeds needed
easier harvesting
faster and more uniform ripening
longer shelf-life
longer panicles
delay of senescence
stronger and/or more productive tillers
better extractability of ingredients
improved quality of seeds (for being seeded in the following seasons for seed production)
better nitrogen uptake
improved reproduction
reduced production of ethylene and/or the inhibition of its reception by the plant.

The improvement of the plant vigor according to the present invention particularly means that the improvement of any one or several or all of the above mentioned plant characteristics are improved independently of the pesticidal action of the mixture or active ingredients (components).

Another indicator for the condition of the plant is the “quality” of a plant and/or its products.

In an especially preferred embodiment of the invention, the quality of the treated plant is increased.

In another preferred embodiment of the invention, the quality of the plants treated according to the method of the invention, is increased synergistically.

According to the present invention, enhanced quality means that certain plant characteristics such as the content or composition of certain ingredients are increased or improved by a measurable or noticeable amount over the same factor of the plant produced under the same conditions, but without the application of the mixtures of the present invention. Enhanced quality can be characterized, among others, by following improved properties of the plant or its product:
increased nutrient content
increased protein content
increased content of fatty acids
increased metabolite content
increased carotenoid content
increased sugar content
increased amount of essential amino acids
improved nutrient composition
improved protein composition
improved composition of fatty acids
improved metabolite composition
improved carotenoid composition
improved sugar composition
improved amino acids composition
improved or optimal fruit color
improved leaf color
higher storage capacity
higher processability of the harvested products.

Another indicator for the condition of the plant is the plant's tolerance or resistance to biotic and/or abiotic stress factors. Biotic and abiotic stress, especially over longer terms, can have harmful effects on plants. Biotic stress is caused by living organisms while abiotic stress is caused for example by environmental extremes. According to the present invention, “enhanced tolerance or resistance to biotic and/or abiotic stress factors” means (1.) that certain negative factors caused by biotic and/or abiotic stress are diminished in a measurable or noticeable amount as compared to plants exposed to the same conditions, but without being treated with a mixture according to the invention and (2.) that the negative effects are not diminished by a direct action of the mixture according to the invention on the stress factors, e.g. by its fungicidal or insecticidal action which directly destroys the microorganisms or pests, but rather by a stimulation of the plants' own defensive reactions against said stress factors.

In one embodiment of the invention, the tolerance or resistance to biotic stress of the treated plant is increased.

In one embodiment of the invention, the tolerance or resistance to biotic stress of the plants treated according to the method of the invention, is increased synergistically.

Negative factors caused by biotic stress such as pathogens and pests are widely known and range from dotted leaves to total destruction of the plant. Biotic stress can be caused by living organisms, such as:
pests (for example insects, arachnides, nematodes)
competing plants (for example weeds)
microorganisms such as phythopathogenic fungi and/or bacteria
viruses.

In one preferred embodiment of the invention, the tolerance or resistance to abiotic stress of the treated plant is increased.

In one preferred embodiment of the invention, the tolerance or resistance to abiotic stress of the plants treated according to the method of the invention, is increased synergistically.

Negative factors caused by abiotic stress are also well-known and can often be ob-served as reduced plant vigor (see above), for example: dotted leaves, “burned leaves”, reduced growth, less flowers, less biomass, less crop yields, reduced nutritional value of the crops, later crop maturity, to give just a few examples. Abiotic stress can be caused for example by:
extremes in temperature such as heat or cold (heat stress/cold stress)
strong variations in temperature
temperatures unusual for the specific season
drought (drought stress)
extreme wetness
high salinity (salt stress)
radiation (for example by increased UV radiation due to the decreasing ozone layer)
increased ozone levels (ozone stress)
organic pollution (for example by phythotoxic amounts of pesticides)
inorganic pollution (for example by heavy metal contaminants).

As a result of biotic and/or abiotic stress factors, the quantity and the quality of the stressed plants, their crops and fruits decrease. As far as quality is concerned, reproductive development is usually severely affected with consequences on the crops which are important for fruits or seeds. Synthesis, accumulation and storage of proteins are mostly affected by temperature; growth is slowed by almost all types of stress; polysaccharide synthesis, both structural and storage is reduced or modified: these effects result in a decrease in biomass (yield) and in changes in the nutritional value of the product.

Advantageous properties, obtained especially from treated seeds, are e.g. improved germination and field establishment, better vigor and/or a more homogen field establishment.

As pointed out above, the above identified indicators for the health condition of a plant may be interdependent and may result from each other. For example, an increased resistance to abiotic stress may lead to a better plant vigor, e.g. to better and bigger crops, and thus to an increased yield. Inversely, a more developed root system may result in an increased resistance to abiotic stress. However, these interdependencies and interactions are neither all known nor fully understood and therefore the different indicators are described separately.

In one embodiment the use of the mixtures within the methods according to the invention results in an increased yield of a plant or its product.

In another embodiment the use of the mixtures within the methods according to the invention results in an increased vigor of a plant or its product.

In another embodiment the use of the mixtures within the methods according to the invention results in an increased quality of a plant or its product.

In yet another embodiment the use of the mixtures within the methods according to the invention results in an increased tolerance and/or resistance of a plant or its product against biotic and/or abiotic stress.

Within the method according to the invention, pyraclostrobin or a mixture comprising pyraclostrobin and at least one insecticide or fungicide is applied at step 2) during the BBCH growth stages 51 through 79.

In a preferred embodiment of the method according to the invention, pyraclostrobin or a mixture comprising pyraclostrobin and at least one insecticide or fungicide is applied at step 2) once during the BBCH growth stages 51 through 69 and again during the BBCH growth stages 69 through 79.

In another preferred embodiment of the method according to the invention, pyraclostrobin or a mixture comprising pyraclostrobin and at least one insecticide or fungicide is applied at step 2) once during the BBCH growth stages 67 through 69 and again at the BBCH growth stage 73.

Within the method according to the invention, glyphosate or a mixture comprising glyphosate and a strobilurin fungicide is applied at step 1b) during the BBCH growth stages 11 through 19.

In a preferred embodiment of the method according to the invention, glyphosate or a mixture comprising glyphosate and a strobilurin fungicide is applied at step 1b) during the BBCH growth stages 12 through 19.

In an even more preferred embodiment of the method according to the invention, glyphosate or a mixture comprising glyphosate and a strobilurin fungicide is applied at step 1b) during the BBCH growth stages 13 through 16.

Within the method according to the invention, the treatment in step 1) is carried out by treating glyphosate-resistant plant propagation material. The treatments in step 1b) and 2) are carried out as foliar application.

When applying the mixture in step 1) according to the present invention, the compounds are applied to the glyphosate-resistant plant propagation material preferably simultaneously (together or separately) or subsequently.

In case of a subsequent application of the compounds, the application is carried out with a time interval which allows a combined action of the applied compounds. Preferably, the time interval for a subsequent application, ranges from a few seconds up to 3 months, preferably, from a few seconds up to 1 month, more preferably from a few seconds up to 2 weeks, even more preferably from a few seconds up to 3 days and in particular from 1 second up to 24 hours.

In a preferred embodiment, the mixture comprising glyphosate and a strobilurin fungicide is applied at step 1b) as a tank mix.

The application of the compounds or the mixtures comprising the respective compounds during step 1b) and/or step 2) of the method according to the invention may be carried out as ground and/or air application.

In one embodiment of the invention, pyraclostrobin or a mixture comprising pyraclostrobin and at least one insecticide or fungicide is applied at step 2) once during the reproductive growth stage of the glyphosate-resistant plant.

In a preferred embodiment of the invention, pyraclostrobin or a mixture comprising pyraclostrobin and at least one insecticide or fungicide is applied at step 2) two times during the reproductive growth stage of the plant.

In a preferred embodiment of the invention, pyraclostrobin or a mixture comprising pyraclostrobin and at least one insecticide or fungicide is applied at step 2) two times during the reproductive growth stage of the glyphosate-resistant plant.

In another embodiment of the invention, pyraclostrobin or a mixture comprising pyraclostrobin and at least one insecticide or fungicide is applied at step 2) three, four or even five times during the reproductive growth stage of the plant.

In another embodiment of the invention, pyraclostrobin or a mixture comprising pyraclostrobin and at least one insecticide or fungicide is applied at step 2) three, four or even five times during the reproductive growth stage of the glyphosate-resistant plant.

In one embodiment of the invention, glyphosate or a mixture comprising glyphosate and a strobilurin fungicide is applied as a third step 1b) once to the glyphosate-resistant plant, part of the plant and/or locus where the plant is growing, at any time during the vegetative growth stage.

In another embodiment of the invention, glyphosate or a mixture comprising glyphosate and a strobilurin fungicide is applied as a third step 1b) two times to the glyphosate-resistant plant, part of the plant and/or locus where the plant is growing, at any time during the vegetative growth stage.

In yet another embodiment of the invention, glyphosate or a mixture comprising glyphosate and a strobilurin fungicide is applied as a third step 1b) three, four or even five times to the glyphosate-resistant plant, part of the plant and/or locus where the plant is growing, at any time during the vegetative growth stage.

As a matter of course, the compounds applied are used in an effective and non-phytotoxic amount. This means that they are used in a quantity which allows to obtain the desired effect but which does not give rise to any phytotoxic symptom on the treated plant or on the plant raised from the treated propagule or treated soil. Effective application rates with respect to the method according to the invention can be influenced by many parameters such as the environment and should therefore be determined under actual growing conditions.

In the treatment of plant propagules, preferably seed, application rates of a mixture of the present invention are generally from 0.001 to 1000 g per 250 kg of plant propagules, preferably from 0.01 to 500 g per 100 kg, in particular from 0.1 g to 250 g per 100 kg of plant propagules.

For use in crop protection, the application rates are between 0.01 and 2.0 kg of active ingredient per hectare, depending on various parameters such as the plant species.

In the methods according to the invention, the application rates according to the invention are from 0.3 g/ha to 2000 g/ha, preferably 20 g/ha to 1000 g/ha, more preferably from 25 to 250 g/ha, in particular from 50 to 150 g/ha, depending on the type of compound and the desired effect.

When using glyphosate, the application rates are in the range of from 0.1 to 6.0 kg of active ingredient (acid equivalent) per hectare, preferably 0.3 to 2.0 kg active ingredient (acid equivalent) per hectare, most preferably 0.7 to 1.0 kg active ingredient (acid equivalent) per hectare depending on the weather conditions and the plant species.

The weight ratio within the mixtures of the present invention, is preferably from 200:1 to 1:200, more preferably from 100:1 to 1:100, more preferably from 50:1 to 1:50 and in particular from 20:1 to 1:20. The utmost preferred ratio is 1:10 to 10:1.

The compounds according to the invention can be present in different crystal modifications whose biological activity may differ. They are likewise subject matter of the present invention.

All compounds or mixtures according to the present invention can be applied (as seed treatment, foliar spray treatment, in-furrow application or by any other means) to glyphosate-resistant plants which naturally occur or which have been obtained by breeding, mutagenesis or genetic engineering including but not limiting to agricultural biotech products on the market or in development (cf. http://www.bio.org/speeches/pubs/er/agri_products.asp).

Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transtional modification of protein(s), oligo- or polypeptides e.g. by glycosylation or polymer additions such as prenylated, acetylated or farnesylated moieties or PEG moieties.

Plants that have been modified by breeding, mutagenesis or genetic engineering, e.g. have been rendered tolerant to applications of specific classes of herbicides. Tolerance to herbicides can be obtained by creating insensitivity at the site of action of the herbicide by expression of a target enzyme which is resistant to herbicide; rapid metabolism (conjugation or degradation) of the herbicide by expression of enzymes which inactivate herbicide; or poor uptake and translocation of the herbicide. Examples are the expression of enzymes which are tolerant to the herbicide in comparison to wild-type enzymes, such as the expression of 5-enolpyruvylshikimate-3-phosphate synthase (EPSPS), which is tolerant to glyphosate (see e.g. Heck et. al, Crop Sci. 45, 2005, 329-339; Funke et. al, PNAS 103, 2006, 13010-13015; U.S. Pat. No. 5,188,642, U.S. Pat. No. 4,940,835, U.S. Pat. No. 5,633,435, U.S. Pat. No. 5,804,425, U.S. Pat. No. 5,627,061), the expression of glutamine synthase which is tolerant to glufosinate and bialaphos (see e.g. U.S. Pat. No. 5,646,024, U.S. Pat. No. 5,561,236) and DNA constructs coding for dicamba-degrading enzymes (see e.g. for general reference US 2009/0105077, and e.g. U.S. Pat. No. 7,105,724 for dicamba resistance in bean, maize (for maize see also WO 2008051633), cotton (for cotton see also U.S. Pat. No. 5,670,454), pea, potato, sorghum, soybean (for soybean see also U.S. Pat. No. 5,670,454), sunflower, tobacco, tomato (for tomato see also U.S. Pat. No. 5,670,454)). Gene constructs can be obtained, for example, from microorganism or plants, which are tolerant to said herbicides, such as the Agrobacterium strain CP4 EPSPS which is resistant to glyphosate; Streptomyces bacteria which are resistance to glufosinate; Arabidopsis, Daucus carotte, Pseudomonoas sp. or Zea mais with chimeric gene sequences coding for HDDP (see e.g. WO 1996/38567, WO 2004/55191); Arabidopsis thaliana which is resistant to protox inhibitors (see e.g. US 2002/0073443).

Examples of currently commercially available plants with tolerance to herbicides, are the corn varieties “Roundup Ready® Corn”, “Roundup Ready 2®” (Monsanto), “Agrisure GT®”, “Agrisure GT/CB/LL”, “Agrisure GT/RW®”, “Agrisure 3000GT®” (Syngenta), “YieldGard VT Rootworm/RR2®” and “YieldGard VT Triple®” (Monsanto) with tolerance to glyphosate; the corn varieties “Liberty Link®” (Bayer), “Herculex I®”, “Herculex RW®”, “Herculex® Xtra” (Dow, Pioneer), “Agrisure GT/CB/LL®” and “Agrisure CB/LL/RW®” (Syngenta) with tolerance to glufosinate; the soybean varieties “Roundup Ready® Soybean” (Monsanto) and “Optimum GAT®” (DuPont, Pioneer) with tolerance to glyphosate; the cotton varieties “Roundup Ready®Cotton” and “Roundup Ready Flex® (Monsanto) with tolerance to glyphosate; the cotton variety “FiberMax Liberty Link® (Bayer) with tolerance to glufosinate; the cotton variety “BXN® (Calgene) with tolerance to bromoxynil; the canola varieties “Navigator® and “Compass(” (Rhone-Poulenc) with bromoxynil tolerance; the canola variety “Roundup Ready(Canola” (Monsanto) with glyphosate tolerance; the canola variety “InVigor® (Bayer) with glufosinate tolerance; the rice variety “Liberty Link® Rice” (Bayer) with glulfosinate tolerance and the alfalfa variety “Roundup Ready Alfalfa” with glyphosate tolerance. Further modified plants with herbicide resistance are commonly known, for instance alfalfa, apple, eucalyptus, flax, grape, lentils, oil seed rape, peas, potato, rice, sugar beet, sunflower, tobacco, tomato, turf grass and wheat with tolerance to glyphosate (see e.g. U.S. Pat. No. 5,188,642, U.S. Pat. No. 4,940,835, U.S. Pat. No. 5,633,435, U.S. Pat. No. 5,804,425, U.S. Pat. No. 5,627,061); beans, soybean, cotton, peas, potato, sunflower, tomato, tobacco, corn, sorghum and sugarcane with tolerance to dicamba (see e.g. US 2009/0105077, U.S. Pat. No. 7,105,724 and U.S. Pat. No. 5,670,454); pepper, apple, tomato, hirse, sunflower, tobacco, potato, corn, cucumber, wheat, soybean and sorghum with tolerance to 2,4-D (see e.g. U.S. Pat. No. 6,153,401, U.S. Pat. No. 6,100,446, WO 05/107437, U.S. Pat. No. 5,608,147 and U.S. Pat. No. 5,670,454); sugar beet, potato, tomato and tobacco with tolerance to glufosinate (see e.g. U.S. Pat. No. 5,646,024, U.S. Pat. No. 5,561,236); canola, barley, cotton, juncea, lettuce, lentils, melon, millet, oats, oilseed rape, potato, rice, rye, sorghum, soybean, sugar beet, sunflower, tobacco, tomato and wheat with tolerance to acetolactate synthase (ALS) inhibiting herbicides, such as triazolopyrimidine sulfonamides and growth inhibitors (see e.g. U.S. Pat. No. 5,013,659, WO 06/060634, U.S. Pat. No. 4,761,373, U.S. Pat. No. 5,304,732, U.S. Pat. No. 6,211,438, U.S. Pat. No. 6,211,439 and U.S. Pat. No. 6,222,100); cereal, sugar cane, rice, corn, tobacco, soybean, cotton, rapeseed, sugar beet and potato with tolerance to HPPD inhibitor herbicides (see e.g. WO 04/055191, WO 96/38567, WO 97/049816 and U.S. Pat. No. 6,791,014); wheat, soybean, cotton, sugar beet, rape, rice, corn, sorghum and sugar cane with tolerance to protoporphyrinogen oxidase (PPO) inhibitor herbicides (see e.g. US 2002/0073443, US 20080052798, Pest Management Science, 61, 2005, 277-285). The methods of producing such herbicide resistant plants are generally known to the person skilled in the art and are described, for example, in the publications mentioned above.

Furthermore, plants are also covered that are by the use of recombinant DNA techniques capable to synthesize one or more insecticidal proteins, especially those known from the bacterial genus Bacillus, particularly from Bacillus thuringiensis, such as δ-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are disclosed, e.g., in EP A 374 753, WO 93/007278, WO 95/34656, EP A 427 529, EP A 451 878, WO 03/18810 and WO 03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the CrylAb toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e.g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP A 392 225), plant disease resistance genes (e.g. potato cultivars, which express resistance genes acting against Phytophthora infestans derived from the mexican wild potato Solanum bulbocastanum) or T4-lysozym (e.g. potato cultivars capable of synthesizing these proteins with increased resistance against bacteria such as Erwinia amylvora). The methods for producing such genetically modified plants are generally known to the person skilled in the art and are described, e.g. in the publications mentioned above.

Furthermore, plants are also covered that are by the use of recombinant DNA techniques capable to synthesize one or more proteins to increase the productivity (e.g. biomass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada). Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

In a preferred embodiment, the plants used in the methods of the present invention are those, which are rendered tolerant to the herbicide glyphosate. The glyphosate-resistant plant propagation material or plant may, however, carry further traits as listed above.

If a herbicide is used for seed treatment, the herbicide is preferably applied on the respective herbicide tolerant plant. Examples of suitable transgenic plants resistant to herbicides are mentioned above.

To prevent damage by the herbicide by seed treatment, the respective herbicide can be combined with a suitable safener to prevent phytotoxic damage by the herbicide. Suitable safeners can be selected from the following listing: cyprosulfamide, 8-quinolinyl-oxy acetic acids (such as cloquintocet-mexyl), 1-phenyl-5-haloalkyl-1,2,4-triazole-3-carboxylic acids (such as fenchlorazole and fenchlorazole-ethyl), 1-phenyl-5-alkyl-2-pyrazoline-3,5-dicarboxylic acid (such as mefenpyr and mefenpyr-diethyl), 4,5-dihydro-5,5-diary)-1,2-oxazole-3-carboxylic acids (such as isoxadifen and isoxadifen-ethyl), dichloroacetamides (such as dichlormid, furilazole, dicyclonon and benoxacor), alpha-(alkoxyimino)-benzeneacetonitrile (such as cyometrinil and oxabetrinil), aceto-phenone oximes (such as fluxofenim), 4,6-dihalogeno-2-phenylpyrimidines (such as fenclorim), N-((4-alkylcarbamoyl)-phenylsulfonyl)-2-benzamides (such as cyprosul-famide), 1,8-naphthalic anhydride, 2-halo-4-haloalkyl-1,3-thiazole-5-carboxylic acids and 2-halo-4-haloalkyl-1,3-thiazole-5-carboxylates (such as flurazole), N-alkyl-O-phenyl carbamates (such as mephenate), N-alkyl-N′-aryl ureas (such as daimuron and cumy-luron), S-alkyl-N-alkyl-thiocarbamates (such as dimepiperate) and phosphorothioates (such as dietholate) as well as their agriculturally useful salts; as well as their agriculturally useful derivaties, such as amides, esters and thioesters in case of present car-boxylic acid functions.

Alternatively, the seed material can be coated beforehand with an active substance-free polymer film. Suitable methods are known to the person skilled in the art. For example, WO 04/049778 describes a method in which, in a first step, the seed material is coated with an active substance-free polymer film before applying a dressing formulation. In addition, potential phytotoxic effects may be avoided using encapsulation technologies for the herbicide in question.

Preferred herbicides, which are used on the respective resistant plant propagation materials are amino acid derivatives such as bilanafos, glyphosate, glufosinate, sulfosate, more preferably glyphosate and glufosinate, most preferably glyphosate.

For use according to the present invention, the inventive mixtures can be converted into the customary formulations, for example solutions, emulsions, suspensions, dusts, powders, pastes and granules. The use form depends on the particular intended purpose; in each case, it should ensure a fine and even distribution of the mixtures according to the present invention. The formulations are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 and ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation Technology (Wiley VCH Verlag, Weinheim, 2001).

The agrochemical formulations may also comprise auxiliaries which are customary in agrochemical formulations. The auxiliaries used depend on the particular application form and active substance, respectively. Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g. for seed treatment formulations).

Suitable solvents are water, organic solvents such as mineral oilfractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e.g. amines such as N-methylpyrrolidone.

Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wetters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalene-sulfonic acid (Nekal® types, BASF, Germany), and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquid and proteins, denatured proteins, polysaccharides (e.g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers thereof.

Examples for thickeners (i.e. compounds that impart a modified flowability to formulations, i.e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA).

Bactericides may be added for preservation and stabilization of the formulation. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Examples for suitable anti-freezing agents are ethylene glycol, propylene glycol, urea and glycerin. Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned and the designations rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108. Examples for tackifiers or binders are polyvinylpyrrolidons, polyvinylacetates, polyvinyl alcohols and cellulose ethers (Tylose®, Shin-Etsu, Japan).

Powders, materials for spreading and dusts can be prepared by mixing or concomitantly grinding the compounds (I) and/or (II) and/or (III) and, if appropriate, further active substances, with at least one solid carrier.

Granules, e.g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Examples for formulation types are:

1. Composition types for dilution with water

### i) Water-soluble Concentrates (SL, LS)

10 parts by weight of compounds of the inventive mixtures are dissolved in 90 parts by weight of water or in a water-soluble solvent. As an alternative, wetting agents or other auxiliaries are added. The active substance dissolves upon dilution with water. In this way, a formulation having a content of 10% by weight of active substance is obtained.

### ii) Dispersible Concentrates (DC)

20 parts by weight of compounds of the inventive mixtures are dissolved in 70 parts by weight of cyclohexanone with addition of 10 parts by weight of a dispersant, e.g. poly-vinylpyrrolidone. Dilution with water gives a dispersion. The active substance content is 20% by weight.

iii) Emulsifiable Concentrates (EC)

15 parts by weight of compounds of the inventive mixtures are dissolved in 75 parts by weight of xylene with addition of calcium dodecylbenzenesulfonate and castor oil ethoxylate (in each case 5 parts by weight). Dilution with water gives an emulsion. The composition has an active substance content of 15% by weight.

### iv) Emulsions (EW, EO, ES)

25 parts by weight of compounds of the inventive mixtures are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The composition has an active substance content of 25% by weight.

### v) Suspensions (SC, OD, FS)

In an agitated ball mill, 20 parts by weight of compounds of the inventive mixtures are comminuted with addition of 10 parts by weight of dispersants and wetting agents and 70 parts by weight of water or an organic solvent to give a fine active substance sus-pension. Dilution with water gives a stable suspension of the active substance. The active substance content in the composition is 20% by weight.

### vi) Water-dispersible Granules and Water-soluble Granules (WG, SG)

50 parts by weight of compounds of the inventive mixtures are ground finely with addi-tion of 50 parts by weight of dispersants and wetting agents and prepared as water-dispersible or water-soluble granules by means of technical appliances (e.g. extrusion, spray tower, fluidized bed). Dilution with water gives a stable dispersion or solution of the active substance. The composition has an active substance content of 50% by weight.

vii) Water-dispersible Powders and Water-soluble Powders (WP, SP, SS, WS)

75 parts by weight of compounds of the inventive mixtures are ground in a rotor-stator mill with addition of 25 parts by weight of dispersants, wetting agents and silica gel. Dilution with water gives a stable dispersion or solution of the active substance. The active substance content of the composition is 75% by weight.

viii) Gel (GF)

In an agitated ball mill, 20 parts by weight of compounds of the inventive mixtures are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

2. Composition types to be applied undiluted

### ix) Dustable Powders (DP, DS)

5 parts by weight of compounds of the inventive mixtures are ground finely and mixed intimately with 95 parts by weight of finely divided kaolin. This gives a dustable compo-sition having an active substance content of 5% by weight.

### x) Granules (GR, FG, GG, MG)

0.5 parts by weight of compounds of the inventive mixtures is ground finely and associ-ated with 99.5 parts by weight of carriers. Current methods are extrusion, spray-drying or the fluidized bed. This gives granules to be applied undiluted having an active sub-stance content of 0.5% by weight.

### xi) ULV Solutions (UL)

10 parts by weight of compounds of the inventive mixtures are dissolved in 90 parts by weight of an organic solvent, e.g. xylene. This gives a composition to be applied undi-luted having an active substance content of 10% by weight.

The agrochemical formulations generally comprise between 0.01 and 95%, preferably between 0.1 and 90%, most preferably between 0.5 and 90%, by weight of active sub-stances. The compounds of the inventive mixtures are employed in a purity of from 90% to 100%, preferably from 95% to 100% (according to NMR spectrum).

The compounds of the inventive mixtures can be used as such or in the form of their compositions, e.g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the compounds present in the inventive mixtures.

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active sub-stance, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001 to 10%, preferably from 0.001 to 1% by weight of compounds of the mixtures used in the inventive method.

The compounds of the inventive mixtures may also be used successfully in the ultra-low-volume process (ULV), it being possible to apply compositions comprising over 95% by weight of active substance, or even to apply the active substance without additives.

Various types of oils, wetters, adjuvants, herbicides, fungicides, other pesticides, or bactericides may be added to the active compounds, if appropriate not until immediately prior to use (tank mix). These agents can be admixed with the compounds of the inventive mixtures in a weight ratio of 1:100 to 100:1, preferably 1:10 to 10:1.

Compositions of this invention may also contain fertilizers such as ammonium nitrate, urea, potash, and superphosphate, phytotoxicants and plant growth regulators and safeners. These may be used sequentially or in combination with the above-described compositions, if appropriate also added only immediately prior to use (tank mix). For example, the plant(s) may be sprayed with a composition of this invention either before or after being treated with the fertilizers.

The compounds contained in the mixtures as defined above can be applied simultaneously, that is jointly or separately, or in succession, the sequence, in the case of separate application, generally not having any effect on the result of the control measures.

In the mixtures applied within the method according to the invention, the weight ratio of the compounds generally depends on the properties of the compounds.

The compounds used as mixtures can be used individually or already partially or completely mixed with one another to prepare the composition according to the invention. It is also possible for them to be packaged and used further as combination composition such as a kit of parts.

In one embodiment of the invention, the kits may include one or more, including all, components that may be used to prepare a subject agrochemical composition. One or more of the components may already be combined together or pre-formulated. In those embodiments where more than two components are provided in a kit, the components may already be combined together and as such are packaged in a single container such as a vial, bottle, can, pouch, bag or canister. In other embodiments, two or more components of a kit may be packaged separately, i.e., not pre-formulated. As such, kits may include one or more separate containers such as vials, cans, bottles, pouches, bags or canisters, each container containing a separate component for an agrochemical composition. In both forms, a component of the kit may be applied separately from or together with the further components or as a component of a combination composition according to the invention for preparing the composition according to the invention.

The user applies the composition according to the invention usually from a predosage device, a knapsack sprayer, a spray tank or a spray plane. Here, the agrochemical composition is made up with water and/or buffer to the desired application concentration, it being possible, if appropriate, to add further auxiliaries, and the ready-to-use spray liquid or the agrochemical composition according to the invention is thus obtained. Usually, 50 to 500 liters of the ready-to-use spray liquid are applied per hectare of agricultural useful area, preferably 50 to 400 liters.

According to one embodiment, individual compounds of the mixtures formulated as composition (or formulation) such as parts of a kit or parts of the mixture may be mixed by the user himself in a spray tank and further auxiliaries may be added, if appropriate (tank mix).

In a further embodiment, either individual compounds of the mixtures formulated as composition or partially premixed components, may be mixed by the user in a spray tank and further auxiliaries and additives may be added, if appropriate (tank mix).

In a further embodiment, either individual components of the composition according to the invention or partially premixed components, can be applied jointly (e.g. after tankmix) or successively.

The term “effective amount” denotes an amount of the inventive mixtures, which is sufficient for achieving the synergistic plant health effects, in particular the yield effects as defined herein. More exemplary information about amounts, ways of application and suitable ratios to be used is given below. Anyway, the skilled artisan is well aware of the fact that such an amount can vary in a broad range and is dependent on various factors, e.g. the treated cultivated plant or material and the climatic conditions.

When preparing the mixtures, it is preferred to employ the pure active compounds, to which further active compounds against pests, such as insecticides, herbicides, fungicides or else herbicidal or growth-regulating active compounds or fertilizers can be added as further active components according to need.

The mixtures are employed by treating the plant, plant propagation material (preferably seed), soil, area, material or environment in which a plant is growing or may grow with an effective amount of the active compounds.

Seed treatment can also be made into the seed box before planting into the field.

For seed treatment purposes, the weight ratio in the binary or ternary mixtures of the present invention generally depends on the properties of the compounds of the mixtures used in the method according to the invention.

Compositions, which are especially useful for seed treatment are e.g.:

A Soluble concentrates (SL, LS)

### D Emulsions (EW, EO, ES)

### E Suspensions (SC, OD, FS)

F Water-dispersible granules and water-soluble granules (WG, SG)
G Water-dispersible powders and water-soluble powders (WP, SP, WS)

### H Gel-formulations (GF)

I Dustable powders (DP, DS)

These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and corn-positions thereof, respectively, on to plant propagation material, especially seeds, are known in the art, and include dressing, coating, pelleting, dusting and soaking application methods of the propagation material (and also in furrow treatment). In a preferred embodiment, the compounds or the compositions thereof, respectively, are applied on to the plant propagation material by a method such that germination is not induced, e.g. by seed dressing, pelleting, coating and dusting.

In the treatment of plant propagation material (preferably seed), the application rates of the inventive mixture are generally for the formulated product (which usually comprises from 10 to 750 g/l of the active(s)).

The invention also relates to the propagation products of plants, and especially the seed comprising, that is, coated with and/or containing, a mixture as defined above or a composition containing the mixture of two or more active ingredients or a mixture of two or more compositions each providing one of the active ingredients. The plant propagation material (preferably seed) comprises the inventive mixtures in an amount of from 0.01 g to 10 kg per 100 kg of plant propagation material (preferably seed).

The separate or joint application of the compounds of the mixtures is carried out by spraying or dusting the seeds, the seedlings, the plants or the soils before or after sowing of the plants or before or after emergence of the plants.

The following examples are intended to illustrate the invention, but without imposing any limitation.

### EXAMPLES

### Example 1

### Soybean

All seed treatments were carried out at the Experimental Station of BASF in ‘Santo Antônio da Posse’, Brazil. The field experiments were carried out at Piracicaba, Brazil. The soybean cultivar which was used was BRS 255 RR from EMBRAPA. Plant population was 300.000 plants, with spacing between rows of 45 cm, respectively. For fertilizing, 84 kg/ha of P₂O₅ and 48 kg/ha of K₂O, respectively, were used and applied at sowing. Sowing dates were Dec. 15, 2008. Trial set up included 4 replications for each treatment with 5 rows of plants with 10 m length. Foliar treatments were applied with a CO₂ equipment (knapsack sprayer), with five cone spray nozzles (nozzle spacing: 0.45 m), using 150 l/ha as an application volume.

A mixture comprising pyraclostrobin, fipronil and thiophanate-methyl (Standak® Top) was applied to glyphosate-resistant plant propagation material according to step 1) of the method according to the invention as seed treatment. During the reproductive growth stage, a mixture comprising pyraclostrobin and epoxiconazole (Opera®) was applied two times to the resulting glyphosate-resistant plant according to step 2) of the method according to the invention as foliar treatment.

The first foliar application (Foliar Treatment 1) of step 2) was carried out during the BBCH growth stages 61 through 65 followed by a second foliar application (Foliar Treatment 2) which was carried out during the BBCH growth stage 71. At the time of harvest, the yield as one key indicator of the health of a plant was determined (table 1).

To show the surprising effect of the method according to the invention, experiments were set up to compare the new and inventive method with established systems known to the person skilled in the art (T4 and T5). All experiments were carried out under comparable conditions. T4 was based on a seed treatment with thiamethoxam (Cruiser®)+fludioxonil+metalaxyl-M (Maxim® XL) and subsequent foliar treatments applying azoxystrobin+cyproconazole (Priori Xtra®). T5 was based on a seed treatment with imidacloprid+thiodicarb (CropStar®)+carbendazim+thiram (Derosal® Plus) and subsequent foliar treatments applying azoxystrobin+cyproconazole (Priori Xtra®).

TABLE 1
Yield of soybean plants

| | | | Foliar Treatment | | | | | |
|---|---|---|---|---|---|---|---|---|
| | Seed Treatment | DR | 1 and 2 | DR | Yield | % YI | % YI | % YI |
| T | (step 1) | ST | (step 2) | FT | (kg/ha) | T1 | T4 | T5 |
| 1 | Untreated | / | Pyraclostrobin + | 0.5 | 3006 | | | |
| | | | epoxiconazole | | | | | |
| 2 | Fipronil + pyraclostrobin + | 50 | Pyraclostrobin + | 0.5 | 3148 | +4.7 | +10.9 | +19.3 |
| | thiophanate-methyl | | epoxiconazole | | | | | |
| 3 | Fipronil + pyraclostrobin + | 100 | Pyraclostrobin + | 0.5 | 3209 | +6.8 | +13.0 | +21.6 |
| | thiophanate-methyl | | epoxiconazole | | | | | |
| 4 | Thiamethoxam + | 100 + 50 | Azoxystrobin + | 0.3 | 2839 | | | |
| | (fludioxonil + metalaxyl-M) | | cyproconazole | | | | | |
| 5 | (Imidacloprid + thiodicarb) + | 300 + 100 | Azoxystrobin + | 0.3 | 2638 | | | |
| | (carbendazim + thiram) | | cyproconazole | | | | | |

T = Treatment;
DR ST = Dose rate at Seed Treatment (× mL/50 kg seed);
DR FT = Dose rate at Foliar Treatment (× L/ha);
% YI T1 = Yield increase (%) in relation to treatment 1 (untreated);
% YI T4 = Yield increase (%) in relation to treatment 4;
% YI T5 = Yield increase (%) in relation to treatment 5.

As can be seen in table 1, the method according to the invention (T2 and T3) resulted in a strong yield increase which was significantly higher than could be expected. The results are especially surprising in the light of the results obtained by comparable systems currently available to the farmer (T4 and T5). The data clearly demonstrates that the increased plant health can not be ascribed to the curative or prophylactic pesticidal effect of the active ingredients applied because the compounds used both in T4 as well as in T5 display a comparable pesticidal effect, however, not resulting in a comparable yield increase as was obtained after applying the method according to the invention (T2 or T3). Apparently the increase in yield and therefore in plant health cannot be attributed to pest control. The effect gets especially evident when comparing T3 and T5. Even though both treatments are able to reliably control pathogenic fungi and insects throughout the complete growing phase, the method according to the invention (T3) was able to surpass the yield of T5 (currently applied method) by almost+22%.

### Example 2

### Corn

All seed treatments were carried out at the Experimental Station of BASF in ‘Santo Antônio da Posse’, Brazil. The corn hybrid which was used was Pioneer-3862. Plant population was 65.000 plants, with spacing between rows of 90 cm, respectively. For fertilizing, 30 kg/ha of N, 90 kg/ha of P₂O₅ and 40 kg/ha of K₂O, respectively, were applied at sowing. Another application of 90 kg/ha of N was carried out at the 4 leaves stage. Sowing date was Dec. 16, 2008. Trial set up included 4 replications for each treatment with 5 rows of plants with 10 m length. Foliar treatments were applied with a CO₂ equipment (knapsack sprayer), with three cone spray nozzles (nozzle spacing: 0.9 m), using 200 l/ha as an application volume.

A mixture comprising pyraclostrobin, fipronil and thiophanate-methyl (Standak® Top) was applied to plant propagation material according to step 1) of the method according to the invention as seed treatment. During the reproductive growth stage, a mixture comprising pyraclostrobin and epoxiconazole (Opera®) was applied once to the resulting plant according to step 2) of the method according to the invention as foliar treatment. The foliar application of step 2) was carried out during the BBCH growth stages 59 through 61. At the time of harvest, the yield as one key indicator of the health of a plant was determined (table 2).

To show the surprising effect of the method according to the invention, experiments were set up to compare the new and inventive method with established systems known to the person skilled in the art (T10 and T11). All experiments were carried out under comparable conditions. T10 was based on a seed treatment with thiamethoxam (Cruiser®)+fludioxonil+metalaxyl-M (Maxim® XL) and a subsequent foliar treatment applying azoxystrobin+cyproconazole (Priori Xtra®). T11 was based on a seed treatment with imidacloprid+thiodicarb (CropStar®)+carbendazim+thiram (Derosal® Plus) and a subsequent foliar treatment applying trifloxystrobin+tebuconazole (Nativo®).

TABLE 2
Yield of corn plants

| | Seed Treatment | DR | Foliar Treatment | DR | Yield | % YI | % YI | % YI |
|---|---|---|---|---|---|---|---|---|
| T | (step 1) | ST | (step 2) | FT | (kg/ha) | T6 | T10 | T11 |
| 6 | Untreated | / | Pyraclostrobin + | 0.75 | 8537 | | | |
| | | | epoxiconazole | | | | | |
| 7 | Fipronil + pyraclostrobin + | 50 | Pyraclostrobin + | 0.75 | 9493 | +11.2 | +8.2 | +9.9 |
| | thiophanate-methyl | | epoxiconazole | | | | | |
| 8 | Fipronil + pyraclostrobin + | 100 | Pyraclostrobin + | 0.75 | 9533 | +11.7 | +8.7 | +10.3 |
| | thiophanate-methyl | | epoxiconazole | | | | | |
| 9 | Fipronil + pyraclostrobin + | 200 | Pyraclostrobin + | 0.75 | 9579 | +12.2 | +9.2 | +10.9 |
| | thiophanate-methyl | | epoxiconazole | | | | | |
| 10 | Thiamethoxam + | 100 + 50 | Azoxystrobin + | 0.30 | 8771 | | | |
| | (fludioxonil + metalaxyl-M) | | cyproconazole | | | | | |
| 11 | (Imidacloprid + thiodicarb) + | 300 + 100 | Trifloxystrobin + | 0.50 | 8641 | | | |
| | (carbendazim + thiram) | | tebuconazole | | | | | |

T = Treatment;
DR ST = Dose rate at Seed Treatment (× mL/50 kg seed);
DR FT = Dose rate at Foliar Treatment (× L/ha);
% YI T6 = Yield increase (%) in relation to treatment 6 (untreated);
% YI T10 = Yield increase (%) in relation to treatment 10;
% YI T11 = Yield increase (%) in relation to treatment 11.

As can be seen in table 2, the method according to the invention (T7, T8 and T9) resulted in a strong yield increase which was significantly higher than could be expected. The results are especially surprising in the light of the results obtained by comparable systems currently available to the farmer (T10 and T11). The data clearly demonstrates that the increased plant health can not be ascribed to the curative or prophylactic pesticidal effect of the active ingredients because both T10 as well as T11 display a comparable pesticidal effect not resulting in a comparable yield increase as was obtained after applying the method according to the invention (T7, T8 or T9). The effect gets especially evident when comparing T9 and T11. Even though both treatments are able to reliably control pathogenic fungi and insects, the method according to the invention (T9) was able to surpass the yield of T11 (currently applied method) by almost+11%. Apparently the increase in yield and therefore in plant health cannot be attributed to pest control.

### Example 3

### Soybean

All seed treatments were carried out at the Experimental Station of BASF in ‘Santo Antônio da Posse’, Brazil. The field experiments were carried out at Piracicaba, Brazil. The soybean cultivar which was used was Coodetec-219RR from COODETEC. Plant population was 311.111 plants, with spacing between rows of 45 cm, respectively. For fertilizing, 60 kg/ha of P₂O₅ and 40 kg/ha of K₂O, respectively, were used and applied at sowing. Sowing dates were Feb. 24, 2010. Trial set up included 4 replications for each treatment with 4 rows of plants with 12 m length. Foliar treatments were applied with a CO₂ equipment (knapsack sprayer), with five cone spray nozzles (nozzle spacing: 0.45 m), using 150 l/ha as an application volume.

A mixture comprising fipronil, pyraclostrobin and thiophanate-methyl (Standak® Top) was applied to glyphosate-resistant plant propagation material according to step 1) of the method according to the invention as seed treatment.

The first foliar application (Foliar Treatment 1) according to step 1b) was a treatment with pyraclostrobin (Comet®) together with glyphosate (Roundup® Ultra; 715 g/L ammonium glyphosate) at BBCH growth stages 14 through 16.

The second application (Foliar Treatment 2) was pyraclostrobin and epoxiconazole (Opera®) which was carried out during the BBCH growth stages 61 through 65 to the glyphosate resistant plants according to step 2) of the method according to the invention followed by a third foliar application (Foliar Treatment 3) which was carried out during the BBCH growth stage 71. At the time of harvest, the yield as one key indicator of the health of a plant was determined (table 3).

To show the surprising effect of the method according to the invention, experiments were set up to compare the new and inventive method (T14) with established systems known to the person skilled in the art (T15). All experiments were carried out under comparable conditions. T15 was based on a seed treatment with imidacloprid+thiodicarb (CropStar®)+carbendazim+thiram (Derosal® Plus) and two subsequent foliar treatments applying azoxystrobin+cyproconazole (Priori Xtra®).

TABLE 3
Yield of soybean plants

| | ST | DR | FT 1 | DR | FT 2 | DR | FT 3 | DR | Yield | % YI | % YI |
|---|---|---|---|---|---|---|---|---|---|---|---|
| T | (step 1) | ST | (step 1b) | FT | (step 2) | FT | (step 2) | FT | (kg/ha) | T13 | T15 |
| 13 | Untreated | / | / | / | P + E | 0.5 | P + E | 0.5 | 2382 | | |
| 14 | F + P + TM | 50 | G + P | 1.5 | P + E | 0.5 | P + E | 0.5 | 3375 | +41.7 | +17.4 |
| | | | | 0.3 | | | | | | | |
| 15 | (I + T) + | 100 | / | / | A + C | 0.3 | A + C | 0.3 | 2874 | +20.6 | |
| | (C + T) | 300 | | | | | | | | | |

T = Treatment;
DR ST = Dose rate at Seed Treatment (× mL/50 kg seed);
DR FT = Dose rate at Foliar Treatment (× L/ha);
% YI T13 = Yield increase (%) in relation to treatment 13 (untreated);
% YI T15 = Yield increase (%) in relation to treatment 15.
F + P + TM = Fipronil + pyraclostrobin + thiophanate-methyl;
G + P = Glyphosate + pyraclostrobin;
P + E = Pyraclostrobin + epoxiconazole;
(I + T) + (C + T) = (Imidacloprid + thiodicarb) + (carbendazim + thiram);
A + C = Azoxystrobin + cyproconazole

As can be seen in table 3, the method according to the invention (T14) resulted in a strong yield increase which was significantly higher than could be expected. The results are especially surprising in the light of the results obtained by comparable systems currently available to the farmer (T15). The data clearly demonstrates that the increased plant health can not be ascribed to the curative or prophylactic pesticidal effect of the active ingredients because T15, even though displaying a comparable pesticidal effect, did not result in a comparable yield increase as was obtained after applying the method according to the invention (T14). Even though both treatments are able to reliably control pathogenic fungi and insects, the method according to the invention (T14) was able to surpass the yield of T15 (currently applied method) by +17%.

1-20. (canceled)

21. A method for increasing the health of a plant comprising:
1) applying to plant propagation material a mixture comprising pyraclostrobin, fipronil and thiophanate-methyl; and
2) applying to the resulting plant, part of the plant and/or locus where the plant is growing, at any time during the reproductive growth stage at least once pyraclostrobin or a mixture comprising pyraclostrobin and at least one insecticide or fungicide.

22. The method according to claim 21, wherein the plant propagation material in step 1) and the resulting plant in step 2) are resistant to glyphosate.

23. The method according to claim 21, wherein the health of a plant is increased both in the presence and absence of biotic or abiotic stress factors.

24. The method according to claim 21, wherein the insecticide in step 2) is selected from the following groups:
(I-1) an organo(thio)phosphate compound selected from the group consisting of chlorpyrifos, chlorpyrifos-methyl and pyraclofos;
(I-2) a carbamate compounds selected from the group consisting of aldicarb, methomyl, thiodicarb and triazamate;
(I-3) a pyrethroid compound selected from the group consisting of bifenthrin, bioethanomethrin, beta-cyfluthrin, biopermethrin, lambda-cyhalothrin, gamma-cyhalothrin, cypermethrin, alpha-cypermethrin, beta-cypermethrin, zeta-cypermethrin, deltamethrin, esfenvalerate, fenvalerate, sulfoxime and thiofluoximate;
(I-4) a juvenile hormone mimic selected from the group consisting of fenoxycarb and pyriproxyfen;
(I-5) a nicotinic receptor agonist/antagonist compound selected from the group consisting of acetamiprid, clothianidin, dinotefuran, imidacloprid, imidaclothiz, thiamethoxam, nitenpyram, paichongding, thiacloprid and tazimcarb;
(I-6) a GABA gated chloride channel antagonist compound selected from the group consisting of acetoprole, ethiprole, fipronil, pyrafluprole, pyriprole and vaniliprole;
(I-7) an METI I compound selected from the group consisting of pyridaben, tebufenpyrad and tolfenpyrad;
(I-8) hydramethylnon;
(I-9) chlorfenapyr;
(I-10) diafenthiuron;
(I-11) a moulting disruptor selected from the group consisting of cyromazine, furan tebufenozide, methoxyfenozide and tebufenozide;
(I-12) a moulting hormone selected from the group consisting of α-ecdysone and ecdysterone;
(I-13) a sodium channel blocker compound selected from the group consisting of indoxacarb and metaflumizone;
(I-14) gonicamid;
(I-15) flucofuron;
(I-16) a chitin synthesis inhibitor selected from the group consisting of buprofezin, bistrifluoron, chlorbenzuron, chlorfluazuron, diflubenzuron, dichlorbenzuron, flucycloxuron, flufenoxuron, hexaflumuron, lufenuron, novaluron, noviflumuron, penfluoron, teflubenzuron and triflumuron;
(I-17) a lipid biosynthesis inhibitor selected from the group consisting of spiromesifen and spirotetramat;
(I-18) flubendiamide;
(I-19) an anthranilamide compound selected from the group consisting of chloranthraniliprole and cyantraniliprole;
(I-20) one or more compounds selected from the group consisting of dicyclanil, metoxadiazone, dimetilan, isoprothiolane, malonoben, sulfoxaflor and triarathene.

25. The method according to claim 21, wherein the further fungicide in step 2) is selected from the following groups:
(F-1) an amine derivative selected from the group consisting of fenpropimorph and fenpropidin;
(F-2) an azole compound selected from the group consisting of bitertanol, bromoconazole, cyproconazole, difenoconazole, diniconazole, enilconazole, epoxiconazole, fenbuconazole, fluquiconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizol and triticonazole;
(F-3) a carboxamide compound selected from the group consisting of bixafen, boscalid, carboxin, fluxapyroxad, isopyrazam, oxycarboxin, sedaxane and fluopyram; and
(F-4) a heterocyclic compound selected from the group consisting of benomyl, carbendazim, thiabendazole and thiophanate-methyl.

26. The method according to claim 22, wherein additionally, as a third step 1b) glyphosate or a mixture comprising glyphosate and a strobilurin fungicide is applied at least once to the glyphosate-resistant plant, part of the plant and/or locus where the plant is growing, at any time during the vegetative growth stage.

27. The method according to claim 26, wherein the strobilurin fungicide is selected from the group consisting of azoxystrobin, dimoxystrobin, enestroburin, fluoxastrobin, kresoxim-methyl, metominostrobin, picoxystrobin, pyraclostrobin, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5[1-(3-methylbenzyloxyimino)-ethyl]benzyl)carbamate and 2 (2-(3-(2,6-dichlorophenyl)-1-methyl-allylideneaminooxymethyl)-phenyl)-2-methoxyimino-N methyl-acetamide.

28. The method according to claim 26, wherein the strobilurin fungicide is selected from the group consisting of azoxystrobin, picoxystrobin, pyraclostrobin and trifloxystrobin.

29. The method according to claim 21, wherein the plant propagation material in step 1) is seed.

30. The method according to claim 21, wherein pyraclostrobin or a mixture comprising pyraclostrobin and at least one insecticide or fungicide is applied at step 2) two times during the reproductive growth stage of the plant.

31. The method according to claim 21, wherein pyraclostrobin or a mixture comprising pyraclostrobin and at least one insecticide or fungicide is applied at step 2) during the BBCH (Biologische Bundesanstalt, Bundessortenamt and CHemische Industrie) growth stages 51 through 79.

32. The method according to claim 26, wherein glyphosate or a mixture comprising glyphosate and a strobilurin fungicide is applied at step 1b) during the BBCH (Biologische Bundesanstalt, Bundessortenamt und CHemische Industrie) growth stages 11 through 19.

33. The method according to claim 21, wherein the treatments in step 1b) and 2) are carried out as foliar application.

34. The method according to claim 21, wherein the plant is selected from the group consisting of soybean, sugar cane, sunflower, oilseed rape, rice, corn and cotton.

35. The method according to claim 21, wherein the yield of the treated plant is increased.
